(19) United States
(12) Patent Application Publication
(10) Pub. No.: US 2020/0234332 A1
(43) Pub. Date: Jul. 23, 2020

(54) ESTIMATING AN EFFECTIVENESS OF AN ONLINE AD CAMPAIGN

(71) Applicant: comScore, Inc., Reston, VA (US)

(72) Inventor: Sean Pinkney, Reston, VA (US)

(21) Appl. No.: 16/253,435

(22) Filed: Jan. 22, 2019

(51) Int. Cl. G06Q 30/02

(52) U.S. Cl. CPC G06Q 30/0246; G06Q 30/0277; G06Q 30/0244; G06Q 30/0243

(57) ABSTRACT

Estimating the effectiveness of an online ad campaign is disclosed. Impression data indicative of online ad activity associated with the ad campaign, such as a plurality of online ad impressions, is received. Awareness data indicative of an awareness of select users of the subject of the ad campaign is received. One or more timing characteristics associated with the online ad activity are determined. Using a survival analysis and based on the impression data, the awareness data, and the one or more timing characteristics, one or more factors are determined. The factors may indicate the degree to which one or more associated attributes of online ad activity influence the effectiveness of the ad campaign. The factors may be applied to second impression data indicative of second online ad activity associated with the ad campaign to determine the estimate of the effectiveness of the ad campaign.

### FIELD OF THE INVENTION

This disclosure relates generally to analysis of online ad activity, and more particularly to estimating an effectiveness of an online ad campaign.

### BACKGROUND

In many advertising campaigns designed to promote a party's products or services, online advertising may form a significant component of that effort or indeed all of that effort. For example, ads are often presented within a webpage or other online medium. Generally, a request for such an ad may be initiated by code underlying a webpage. An advertising server or similar system may receive the request and subsequently cause an appropriate ad to be provided to the client device rendering or attempting to render the webpage. The ad may be then inserted into the webpage for intended exposure to the user. As part of this transaction, the party initiating the ad campaign is charged for each presentation—or supposed presentation—of the ad.

Due to such accumulating cost of online advertising, the advertising party is naturally concerned with the returns on investment for such online advertising. That is, the advertising party seeks to determine or estimate the effectiveness of the online advertising in advancing the goals of the advertising campaign. Yet challenges remain in most accurately determining or estimating the effectiveness of the online advertising. For example, it may be uncertain whether an observed user was actually exposed to the online ad. This may be due to the shared nature of one or more client devices associated with the observed user, such as a family computer. Such uncertainty may be further introduced due to failed exposure or even rendering of the online ads caused, for example, by the ad being part of a “pop under” window or in a hidden frame of a webpage.

Accordingly, there is a need for improved methods and systems for estimating an effectiveness of an online ad campaign.

### SUMMARY OF THE DISCLOSURE

In one aspect, a method receives first data indicative of a first plurality of ad impressions associated with a panel of users. The first plurality of ad impressions are further associated with at least a first portion of an ad campaign. Second data is received that indicates an awareness of a subject of the ad campaign by the panel of users. Based on the first data, a first one or more timing characteristics associated with the first plurality of ad impressions is determined. Using a survival analysis and based on the first data, the second data, and the first one or more timing characteristics, one or more factors are determined. The one or more factors are indicative of an estimated effect of one or more attributes of a second plurality of ad impressions to an effectiveness of a second portion of the ad campaign associated with the second plurality of ad impressions.

The method further receives third data indicative of the second plurality of ad impressions associated with the second portion of the ad campaign. Based on the third data and the one or more factors, an estimate of the effectiveness of the second portion of the ad campaign is determined. The second plurality of ad impressions may occur subsequent to the first plurality of ad impressions. The second plurality of ad impressions may be associated with the panel of users.

In an aspect, the one or more factors may be based, additionally or alternatively to the first one or more timing characteristics, on the types of client devices associated with respective ad impressions of the first plurality of ad impressions. A first one or more ad impressions of a subset of the first plurality of ad impressions may be associated with a first device type and a second one or more ad impressions of the subset may be associated with a second device type. The one or more factors may be based on the first one or more ad impressions of the subset being associated with the first device type and the second one or more ad impressions of the subset being associated with the second device type. The subset of the first plurality of ad impressions may be associated with a user of the panel of users.

In an aspect, an attribute of the one or more attributes of the second plurality of ad impressions may comprise a second one or more timing characteristics associated with the second plurality of ad impressions. The estimate of the effectiveness of the second portion of the ad campaign may be based on the second one or more timing characteristics.

In an aspect, a timing characteristic of the first one or more timing characteristics may be indicative of a relative timing of a subset of ad impressions of the first plurality of ad impressions. The subset of ad impressions may be associated with a user of the panel of users. A timing characteristic of the second one or more timing characteristic may be indicative of a relative timing of a subset of ad impressions of the second plurality of ad impressions. The timing characteristic of the second one or more timing characteristics may be associated with the aforementioned user and/or other users of the panel of users.

In an aspect, the subset of ad impressions may comprise a first fast sequence of ad impressions. Each ad impression of the first fast sequence of ad impressions may occur within a predetermined unit of time prior to or following at least one other ad impression of the first fast sequence of ad impressions. The one or more factors may be based on the first fast sequence of ad impressions. The timing characteristic of the first one or more timing characteristics may be indicative of a quantity of ad impressions of the first fast sequence of ad impressions. The one or more factors may be based on the quantity of ad impressions of the first fast sequence of ad impressions. The timing characteristic of the first one or more timing characteristics may be further indicative of an elapsed duration of time of the first fast sequence of ad impressions. The one or more factors may be based on the elapsed duration of time of the first fast sequence of ad impressions.

In an aspect, the subset of ad impressions may comprise a second fast sequence of ad impressions. Each ad impression of the second fast sequence of ad impressions may occur within the predetermined unit of time prior to or following at least one other ad impression of the second fast sequence of ad impressions. The one or more factors may be based on the second fast sequence of ad impressions. The timing characteristic of the first one or more timing characteristics may be indicative of an aggregate elapsed durations of time of the first fast sequence of ad impressions and the second fast sequence of ad impressions. The one or more factors may be based on the aggregate elapsed durations of time.

In an aspect, the subset of ad impressions may comprise one or more slow ad impressions. Each slow ad impression of the one or more slow ad impressions may occur outside of a second predetermined unit of time prior to or following any other ad impression of the subset of ad impressions. The one or more factors may be based on the one or more slow ad impressions. A first subset of the one or more slow ad impressions may be associated with a first device type and a second subset of the one or more slow ad impressions may be associated with a second device type. The one or more factors may be based on the first subset being associated with the first device type and the second subset being associated with the second device type.

In an aspect, the timing characteristic of the first one or more timing characteristics may be indicative of a quantity of slow ad impressions of the one or more slow ad impressions. The one or more factors may be based on the quantity of slow ad impressions of the one or more slow ad impressions. The timing characteristic of the first one or more timing characteristics may be further indicative of inter-occurrence durations of time with respect to each slow ad impression of the one or more slow ad impressions and respective immediately-prior and immediately-subsequent ad impressions of the subset of ad impressions. The one or more factors may be based on the inter-occurrence durations of time.

In an aspect, the determining the estimate of the effectiveness of the second portion of the ad campaign may include weighting one or more ad impressions of the second plurality of ad impressions. The weighting may be based on the one or more factors.

In an aspect, the second data indicative of awareness may be based on one or more surveys submitted to the panel of users. In an aspect, the second data indicative of awareness may be additionally or alternatively based on monitored online activity associated with a user of the panel of users. The monitoring online activity may be associated with the subject of the ad campaign.

In an aspect, the survival analysis may comprise a likelihood function associated with at least one of a likelihood of a user being aware of the subject of the ad campaign and a likelihood of a user being unaware of the subject of the ad campaign. The one or more factors may be based on a fit of the one or more factors to the likelihood function.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

In order that the disclosure may be readily understood, aspects of this disclosure are illustrated by way of examples in the accompanying drawings.

FIG. 1 illustrates an example hardware and network configurations for estimating an effectiveness of an online ad campaign according to an embodiment of the present disclosure.

FIG. 2 illustrates an example webpage according to an embodiment of the present disclosure.

FIG. 3 illustrates an example data flow diagram according to an embodiment of the present disclosure.

FIG. 3 illustrates an example method flow diagram according to an embodiment of the present disclosure.

FIG. 5 illustrates an example method flow diagram according to an embodiment of the present disclosure.

The same reference numbers are used in the drawings and the following detailed description to refer to the same or similar parts.

### DETAILED DESCRIPTION

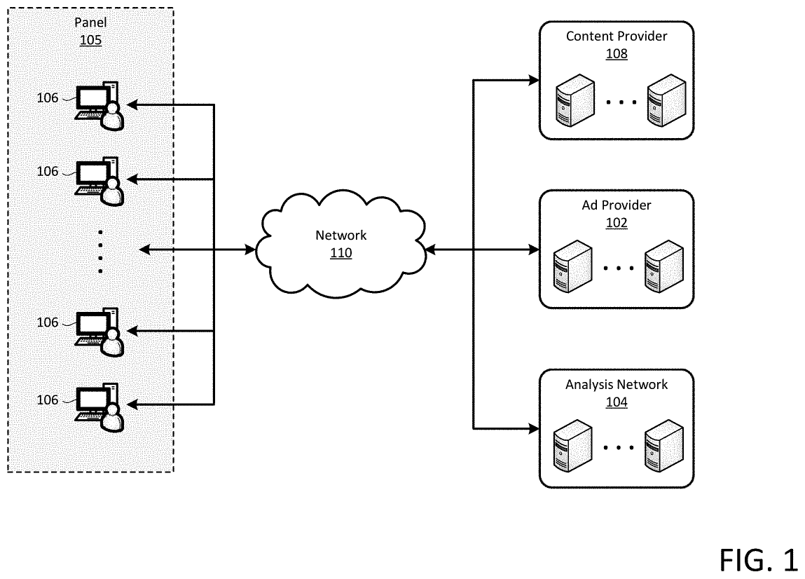

FIG. 1 illustrates exemplary hardware and network configurations for various devices that may be used to perform one or more operations of the described aspects. As shown, a content provider 108, an ad provider 102, an analysis network 104, and a panel 105 of client devices 106 (and/or users of those client devices 106) are in mutual communication via a network 110. A client device 106 may be configured to render a webpage or other online format (e.g., an “app,” mobile or otherwise). The rendered webpage may comprise content provided to the client device 106 by the content provider 108. The webpage rendered by a client device 106 may comprise one or more ad placements in which an ad is rendered, preferably, to effectuate an exposure of the ad to a user. The ad may be supplied by the ad provider 102 to the client device 106 for rendering with the webpage. The analysis network 104 may comprise one or more systems or entities that, for example, monitor, evaluate, and report various aspects of ad delivery, including the extent to which ad impressions associated with an online ad campaign (also referred to herein as simply an ad campaign, unless dictated otherwise) are effective in achieving the objectives of that ad campaign.

The panel 105 may comprise one or more client devices 106. A client device 106 may be realized as non-mobile computing device, such as a desktop computer, laptop computer, set-top gaming device, set-top television device, or an internet-enabled television. Additionally or alternatively, a client device 106 may be a mobile device, such as a cellular phone, smart phone, or tablet computer. A client device 106 may be additionally or alternatively defined according to the software used to effectuate ad delivery. Thus, a client device 106 may be referred to in terms of either a hardware configuration, a software configuration, or both a hardware and software configuration. For example a client device 106 configured to implement ad impressions may be characterized according to whether those ad impressions are implemented using either a web browser or another type of application (“app”). As some examples, a client device 106 may be characterized as a desktop device, a mobile device running a web browser for ad delivery, or a mobile device running an “app” (besides a web browser) for ad delivery. A client device 106 may be additionally or alternatively defined according to the type or configuration of the system at large via which media content and ads are delivered to the client device 106. For example, a client device 106 may be characterized as one that implements ad impressions via an over-the-top (OTT) media service, such as video streaming providers Netflix or Hulu. The type of a client device 106 may be referred to as the “platform” for ad delivery. In an aspect, the client devices 106 are limited to only non-mobile computing devices. The panel 105 may additionally or alternatively refer to users of the client devices 106 according to context.

Some client devices 106 may be associated with a single user and activity on that client device 106 may be reliably attributed to that user. Yet other client devices 106 may be associated with or made available to multiple users, such as a television situated in a common area of a residence or a tablet or other type of computing device that is shared by an entire family. Online activity associated with the multi-user client device 106 may not necessarily be reliably attributed to a single user.

Each of the client devices 106 may be configured with one or more applications (e.g., a web browser) configured to request webpage content and ads, receive said webpage content and ads, and render the content and ads within the application interface. Webpage content and ads may comprise text, video, or images. Webpage content and ads may be provided to the client device 106 in the form of client-side code, such as HTML and JavaScript. The client-side code, when executed by the web browser and/or client device 106, may initiate a request for an ad or webpage content. The client-side code, when executed by the web browser and/or client device 106, may further process a response to the request and cause the requested content or ad to be rendered.

The panel 105 of client devices 106 (and associated users) may serve as a generally-voluntary sample population from which estimates of ad campaign effectiveness and other metrics may be based, at least in part. Data, referred to as panel data, may reflect various aspects of the client devices 106, users of the client devices 106, and online activity associated with the client devices 106 (e.g., user interactions with rendered ads). Panel data may refer to an individual client device 106 and/or user or may collectively refer to the larger panel 105 or a subset of the panel 105.

Panel data may indicate, for example, webpages visited at a client device 106 during a particular period of time, any ads rendered during the period of time, the times or relative timings of the ad renderings, and any user activity (e.g., a click-through) relating to the ads. As another example, panel data may indicate user demographic information. As yet other examples, panel data may indicate a device type, hardware configuration, or software configuration of a client device 106. The panel data may be used to estimate the effectiveness of an ad campaign. For example, the panel data may serve, at least in part, as one or more bases for survival analysis used to estimate the ad campaign effectiveness.

Panel data may be collected via one or more applications voluntarily installed on one or more client devices 106 that monitor and record various aspects of online activity occurring at the client device 106. Panel data may also be collected or determined by other sources, such as an upstream router or other network device configured to monitor network traffic to and from a client device 106. As another example, panel data, such as demographic information, may be provided directly by a user.

A client device 106 and/or an associated user are typically registered as part of the panel 105 but other client devices 106 and/or users may be also considered as part of the panel 105 due to some association with a registered client device 106 or user. Thus the panel data may be delineated, at least in part, according to individual users and/or client devices 106 (e.g., a registered client device 106 or user), multiple associated users or client devices 106, or a combination thereof. For example, multiple users (and activity thereof) represented in panel data may be associated with one another by use of a common device (e.g., a family television or a family computer). As another example, multiple users may be associated with one another as co-habitants of a residence. As another example, multiple users may be associated via a common IP address.

In some cases, panel data may be directly associated with a registered user and/or the user's client device 106, yet this panel data represents, at least in part, online activity of one or more other users associated with the registered user (e.g., other members of the registered user's household). In an example, some online activity represented in the panel data may be directly attributable to the registered user, such as online activity on the registered user's personal mobile device, while other online activity is only generically attributable to the registered user, such as online activity on a shared family computer at the registered user's residence. It is noted that the latter generically-attributable online activity may not reflect the actual online activity of the registered user at all. Thus panel data as a whole may also represent the collective online activity of both the registered user and those other users associated with the user. Panel data may include a subset of panel data that represents the particular online activity of (and is attributable to) a registered user and a second subset of panel data that represents online activity of one or more users that only have some association with the registered user.

Panel data (and data otherwise collected or determined) representing, at least in part, online activity of multiple associated users may introduce some unknown variables into an ad effectiveness analysis due to the uncertainties of whether a single user was exposed to a given ad impression or whether two or more users of the multiple associated users were exposed to the ad impression. Further, it may be unknown which of the user(s) were exposed to the ad impression. For example, panel data may be captured by a family computer. It is unknown, however, whether a single user was operating the computer when an ad was rendered or whether several users were viewing the computer's display when the ad was rendered. In either case, the identities of the user(s) may also be unknown.

Another unknown variable reflected in the panel data that may detrimentally affect ad effectiveness analyses is the relative timing between associated ad impressions, which may be sometimes referred to as the cadence of the ad impressions. For example, repeated impressions of an ad within a limited period of time (a “short run”) may in some cases have a positive effect on ad impression effectiveness. Yet in other cases the repeated ad impressions may inhibit ad impression effectiveness (with respect to each individual ad impression or the ad impressions collectively) due to overexposure—there may be a point at which a user is sufficiently aware of the ad subject and further impressions in the short term have little or no influence on the user's awareness. In other words, high-frequency ad impressions may suffer from diminishing returns.

The uncertainty is further compounded by the possibility that at least some of the ad impressions of a short run are not viewed or in some cases not even rendered in the webpage. This may be due to, for example, ad impressions occurring in frames of a webpage that are not visible, a pop up blocker of a web browser, or ad impressions occurring in a “pop under” window of a web browser. This may also be due to an ad placement error in which the ad is reloaded repeatedly, thus causing the web browser to repeatedly initiate a redirect calling for a 1×1 pixel from the ad provider 102, if the ad is so configured. This may register with the ad provider 102 or other monitoring entity as an exposed ad impression. The repeated requests to the ad provider 102 for the ad may also cause non-viewed ad impressions to be registered. Whatever the cause, non-viewed ad impressions that are registered as viewed ad impressions may improperly skew an estimate of the effectiveness of ad impressions individually or of the ad campaign as a whole. For example, an over-determined number of ad impressions deemed to be viewed may result in a downward bias of the true effectiveness of the registered ad impressions that were actually viewed.

Another timing aspect that may affect ad impression effectiveness to an unknown extent may also relate to the frequency of ad impressions, but with further regard to longer durations of time either between two temporally-isolated ad impressions or between a temporality isolated ad impression and an ad impression of a previous or subsequent fast run. Such a temporally-isolated ad impression may comprise a “slow run.” For example, a sufficiently long duration of time between consecutive ad impressions may result in the user forgetting the previous ad impression by the time a later ad impression is exposed to the user, causing reduced effectiveness of the later ad impression. In other words, the awareness afforded by an ad impression may decay over time.

As noted, the content provider 108 delivers content (e.g., webpage content) to a client device 106 for rendering at the client device 106 via a web browser or other application/hardware configured to present content. The content provider 108 may comprise one or more web servers configured to send, via the network 110, content to a client device 106 in response to a request from the client device 106. Content providers 108 may include website owners or content publishers. For example, content providers 108 may include financial institutions (e.g., Bank of America), email providers (e.g., Gmail), search engines (e.g., Google), media streaming entities (e.g., Netflix), and/or news providers (e.g., CNN). Content providers 108 may be in communication with users of the client devices 106 through publication of websites and/or apps.

The ad provider 102 may comprise an advertiser seeking to market their products or services by running ads on webpages, within apps, or other online format. In some instances, the advertiser may be considered distinct from the ad provider 102, with the advertiser supplying the content of the ad (i.e., the “creative”) and the ad provider 102 performing the technical aspects of ad delivery. The advertiser may include or be associated with an ad broker or agency that coordinates various aspects of ad delivery for the advertiser.

The ad provider 102 may deliver an ad to a client device 106 for the client device 106 to render within an ad placement of a webpage or the like. The ad provider 102 may comprise one or more web servers configured to receive a request from a client device 106 for an ad and respond in kind. The request for the ad may be initiated by client-side code or other instructions embedded in or linked to by webpage data (e.g., HTML, JavaScript, etc.). In some instances, the request may come from the content provider 108 of the webpage and direct the ad provider 102 to deliver the ad to the client device 106 so that the ad may be rendered within an ad placement of the content provider's 108 webpage.

The ad provider 102 may comprise an ad exchange component configured to select an ad based on various criteria and instruct the client device 106 to request the selected ad from the ad provider 102 or other source. The various criteria may include a web browsing history indicated by cookies on the client device 106 or attributes of the webpage initiating the ad request, such as the quantity and quality of web traffic to the webpage. The ad provider 102 may further include an ad attribution component through which, generally, an ad impression is attributed to the content provider 108 (or the associated publisher) of the webpage in which the ad is rendered. Thus payment flows from the ad provider 102 (or the associated advertiser) to the identified content provider 108 or associated publisher. In some aspects, the various functions of the ad provider 102 may be shifted to the content provider 108 or analysis network 104. For example, some aspects of the ad exchange or ad attribution may be shifted to the analysis network 104 or some aspects of the ad provider's 102 web servers may be taken on by the content provider 108.

The analysis network 104 may perform various functions within the advertisement ecosystem. For example, the analysis network 104 may collect the panel data or other data indicating online activity, user demographics, attributes of client device 106, etc. The analysis network 104 may include a monitoring component configured to aggregate the panel data and other similar data. An awareness component of the analysis network 104 may be configured to receive and process data (“awareness data”) reflecting whether or to what degree one or more users (e.g., the users of the panel 105) are aware of the subject of an ad campaign. Such data may include results from a survey given to the one or more users or evidence of ad conversion, such as a user clicking on an ad to view the advertiser's web site. The analysis network 104 may include a survival analysis component configured to process the panel or other data along with the awareness data and thereby determine a survival function or related functions that may be used to estimate the effectiveness of an ad campaign.

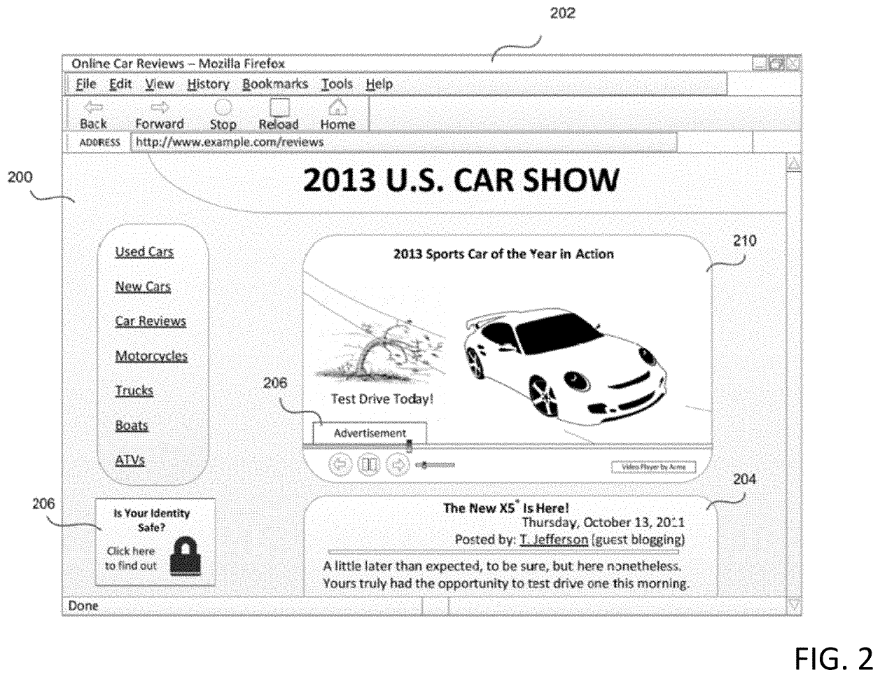

FIG. 2 is a diagram depicting an exemplary webpage 200. The webpage 200 may be that of the content provider 108 or associated publisher. The webpage 200 may be rendered by a web browser 202 on a client device 106 and displayed on a screen of the client device 106. The webpage 200 may include content 204 and at least one ad 206 (i.e., creative). The ad 206 may be a static advertisement, an animated advertisement, a dynamic advertisement, a video advertisement, a public service announcement, or another form of information to be displayed on a screen of the client device 106.

To render the ad 206, the markup language of the webpage 200 may include an ad tag associated with the desired ad 206. For example, if the webpage 200 is coded with Hypertext Markup Language (HTML), the creative tag may be an HTML tag or JavaScript tag that links to the ad 206. The ad tag may direct the client device 106 to retrieve the ad from the ad provider 102. The ad 206 received from the ad provider 102 may be rendered within the ad placement of the webpage 200.

Further, the webpage 200 may have instructions for embedding a video player 210 as a part of the content to be displayed on the page. The video player 210 may be configured to play video content, such as video advertisements, to open executable files, such as Shockwave Flash files, or to execute other instructions. The video player 210 may be a separate component that is downloaded and executed by the web browser 202, such as an Adobe Flash, Apple QuickTime, or Microsoft Silverlight object; a component of the web browser 202 itself, such as a HTML 5.0 video player; or any other type of component able to render and play video content within the web browser 202. The video player may be configured to play featured video content in addition to the ad 206. The video player may also be configured to retrieve the ad 206 through an ad tag that links to the desired ad 206.

The content provider 108, the ad provider 102, the analysis network 104, or other system or entity may track each time the webpage 200, an ad 206, or other web content is requested for and received from its source and/or otherwise delivered to a client device 106. In addition to simply counting the number of requests for the webpage 200 or the number of impressions of an ad 206, the content provider 108, the ad provider 102, the analysis network 104, or other system or entity may track additional related information including an operating system of the client device 106, a web browser, an IP address of the client device 106, a MAC address of the client device 106, a domain of an ad 206, demographic information related to the client device 106, or any other information. At least some of such data may be indicated in the panel data. The information gathered by the content provider 108, the ad provider 102, the analysis network 104, or other system or entity may be used for a variety of purposes, including estimating the effectiveness of an ad campaign via survival analysis.

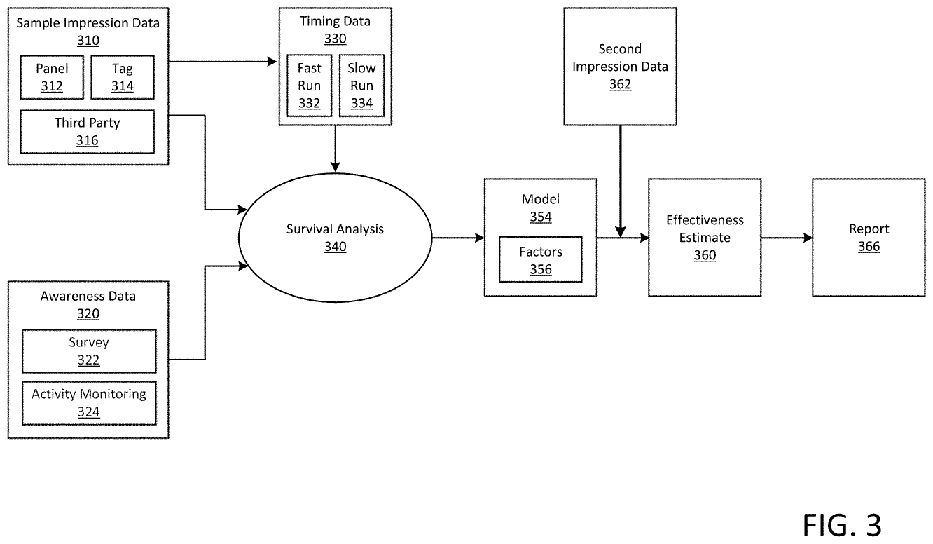

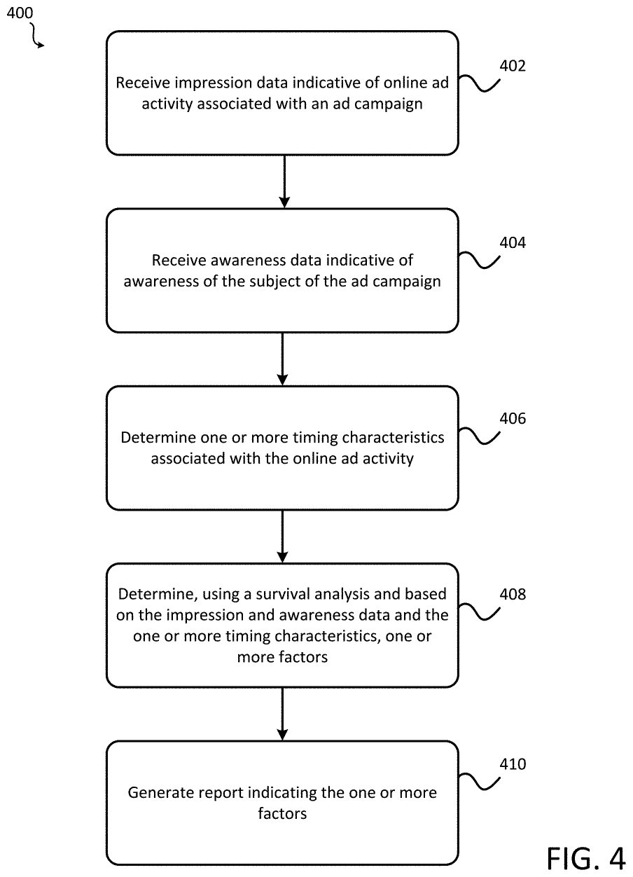

FIG. 3 illustrates a data flow diagram in which sample impression data 310 and awareness data 320 associated with an ad campaign are used to perform a survival analysis 340. The survival analysis 340 may further use timing data 330 derived from the sample impression data 310. Based on the survival analysis 340, a model 354 representing various factors 356 relating to online ad delivery is determined. The factors 356 of the model 354 are applied to corresponding parameters or attributes of another set of impression data (“second impression data 362”). The second impression data 362 may represent later online ad activity associated with the ad campaign. An estimate of the effectiveness of the ad campaign (“effectiveness estimate 360”) is thereby determined. The effectiveness estimate 360 is output as a report 366.

The sample impression data 310 may generally serve as a body of sample data that is subject to the survival analysis 340 and upon which the model 354 is based, at least in part. The sample impression data 310 may be associated with a particular ad campaign or portions of a particular ad campaign. The sample impression data 310 may generally reflect ad delivery (including attempted ad delivery) of the ad campaign. The ad delivery reflected in the sample impression data 310 may be limited to a pre-determined period of time. The pre-determined period of time may correspond with the ad campaign or a pre-determined portion of the ad campaign. The sample impression data 310 may be realized as panel data 312, tag data 314, and/or third party data 316.

The sample impression data 310 may generally reflect various aspects of online ad delivery. The sample impression data 310 may indicate one or more ad impressions (e.g., the ad 206 of FIG. 2) associated with the ad campaign. For example, the sample impression data 310 may indicate the webpage (as well as attributes of that webpage, including the time viewed and the associated content provider/publisher) having the ad placement that caused an ad to be requested and delivered to the client device (e.g., the client device 106 of FIG. 1). The sample impression data 310 may indicate the webpage within which an ad is rendered, such as if this webpage is different than the webpage causing the ad to be requested for and delivered. The sample impression data 310 may indicate the time that an ad was requested, the time that an ad was delivered, the time that an ad was rendered, and/or the time that an ad impression occurred. The sample impression data 310 may indicate user interaction with an ad and/or the webpage containing the ad, such as whether the user clicked on the ad (or otherwise activated the link of the ad). The sample impression data 310 may indicate the time that user interaction with an ad or webpage occurred. The sample impression data 310 may indicate the IP address and/or webpage to which the user is directed based on user interaction with the ad.

As further examples, the sample impression data 310 may reflect network activity (e.g., network traffic) associated with the ad delivery. The sample impression data 310 may further indicate aspects of the client device(s) 106 involved with the ad delivery. The sample impression data 310 may also identify users associated with the ad delivery and attributes of those users.

Network activity or traffic indicated by the sample impression data 310 may include source/destination IP addresses associated with an ad, such as the IP address of the client device requesting the ad and the server or other network resource providing the ad to the client device. The sample impression data 310 relating to network activity or traffic may indicate URLs or domains in HTML headers, domains indicated in HTTP requests (e.g., HTTP requests for an ad), and an associated IP address that is contacted by the client device based on the domain indicated in the HTTP request. The sample impression data 310 may further indicate one or more processes that were executing on the client device 106 and originated an HTTP request for an ad or other network transaction relating to ads.

Sample impression data 310 relating to the client device (“client device data”) may include an identifier of a client device and the type of the client device (e.g., a desktop computer, a mobile cellular device, a set-top box, a television, a web browser, a mobile app, a device configured for OTT media streaming, etc.). The identifier of a client device may be based on one or more of a media access control (MAC) address, a browser cookie stored on the client device, or an assigned advertising ID (e.g., Apple's Identifier for Advertisers (IDFA), Google's Advertising ID, and Microsoft's Advertising ID). The client device data may indicate if a client device is a mobile device or a stationary device. The client device data may indicate if a client device is a shared device (e.g., a family television) or a personal device (e.g., a smartphone). The client device data may indicate if a client device is a personal device of the user registered as a member of the panel. The client device data may indicate an IP address or other network location of the client device. The client device data may indicate the operating system of a client device (e.g., Microsoft Windows, Android, iOS or macOS) and the application rendering the webpage and ad (e.g., Internet Explorer, Google Chrome, Mozilla Firefox, or Safari web browsers). The client device data may further indicate a browsing history, such as that determined from cookies stored on a client device. The client device data associated with a particular client device may indicate other client devices having some association with the particular client device, such as other co-located client devices.

Sample impression data 310 relating to users (“user data”) may indicate the users associated with the indicated ad delivery. The user data may indicate whether a user (or client device(s) of the user) is registered as part of a panel (e.g., the panel 105 of FIG. 1). The user data may include demographic information. For example, user data may indicate a user's age, gender, race, income, address or other location indicator, and occupation. User data may include information about a user's browsing or online activity habits, such as an average time spent online or times of day that a user is online.

As noted, the sample impression data 310 may be realized as the panel data 312. The panel data 312 may include data derived by virtue of a user and/or associated client devices being registered with a panel. For example, a user may indicate demographic information about himself or herself as part of registration with the panel. During panel registration, for example, the user may also indicate information about any client devices associated with the user, including those that are personal client devices and those that are shared client devices. The user may also identify other associated user (e.g., co-located users) and respective demographic information.

The panel data 312 may be collected from one or more applications voluntarily installed on a client device and associated with the panel (“panel application”). The panel application may detect and store information about the webpages visited on the client device and any interactions with said webpages, including interactions with an ad. The panel application may detect and store information about the webpage to which the user is directed by clicking on or otherwise interacting with an ad. The panel application may detect and store the time that a webpage is visited, the time that an ad impression is implemented, and a time that an ad is clicked or otherwise interacted with. As other examples, the panel application may detect and store network traffic data associated with the client device. The panel application may further determine aspects of a client device (e.g., the client device data), including the particular web browser used to view a webpage.

Sample impression data 310 may include tag data 314 that is generated when an ad is rendered, partially rendered, or attempted to be rendered. For example, an ad may be configured with a tag or other indicator that causes a message to be sent to a party associated with delivery of the ad, such as an ad provider (e.g., the ad provider 102 of FIG. 1). The tag may comprise a JavaScript tag. As another example, the ad may be configured with a tag indicating a redirect link to a 1×1 pixel. When attempting to render the pixel, the web browser is redirected to a party associated with delivery of the ad. In either case of the aforementioned message or redirect for the pixel, the associated party records the same as evidence that the ad was delivered and should be attributed to the content provider or publisher of the webpage.

Sample impression data 310 may also include third party data 316. “Third party,” in some instances, may refer to an ad provider (e.g., one equipped with the ad servers) as the third party, with the publisher and the advertiser (distinct in this case from the ad provider) serving as the first and second parties. In other instances, the third party may comprise one or more ad servers that deliver the ad to the client device but are distinct from the initially-described ad provider (e.g., the ad provider 102 of FIG. 1). The third party may record a received request for an ad. The third party may further record the subsequent delivery of the ad to the client device by the third party. As such, the records of the requests and subsequent deliveries may also serve as evidence, at least in part, of an ad impression.

The timing data 330 generally comprises timing aspects of one or more ad impressions and is based on the sample impression data 310, including portions of the sample impression data 310 indicating or partially indicating that an ad impression has occurred. The timing data 330 may include a timestamp indicating the time at which an ad impression has occurred. The timing data 330 may further include a timestamp indicating that an ad is requested and a timestamp indicating that the ad is delivered to the client device from an ad server. It is noted that, although an ad impression may be recorded in the sample impression data 310, it is possible that the ad impression was not viewed by or exposed to a user and the non-viewed/exposed ad impression may fail to be designated as such in the sample impression data 310. It is also possible that the sample impression data 310 indicates an ad impression but the ad impression was not in fact rendered, let alone viewed by the user.

The timing data 330 may be organized, at least in part, according to fast runs of ad impressions and slow runs of ad impressions. That is, fast run data 332 indicates those ad impressions that are part of a fast run and slow data 342 indicates those ad impressions that are part of a slow run. An ad impression forming part of a fast run may be referred to as a fast ad impression and an ad impression forming a slow run may be referred to as a slow ad impression. A slow run may be variously referred to as a long run (comprising a long ad impression) and a fast run may be variously referred to as a short run (comprising fast ad impressions).

The timing data 330 may be further organized according to the client device that performed the ad impression. The timing data 330 may be further organized according to the user associated with the ad impression, which may include the user that viewed the ad impression or is purported to have viewed the ad impression. The timing data 330 may be further organized according to the content of the ad impression. For example, in some cases, several ad impressions may be considered as part of the same run only if they share identical content. Yet in other cases, several ad impressions may be considered as part of the same run despite each featuring content different from one another. The different content may all be associated with the same ad campaign.

Each ad impression of a run may be associated with a particular client device. For example, each ad impression of a run is indicated to have been performed on the client device. Yet in some embodiments, a run may span more than one client device, such as if each client device is associated with the same user. For example, an ad impression on a first client device followed within a pre-determined time duration by another ad impression on a second client device may together be considered a fast run if they otherwise meet the criteria for a fast run. Each ad impressions of a run may be associated with a particular user. In the aforementioned example involving the first and second client devices, the two ad impressions on the two client devices may be considered a fast run by virtue of the first and second client devices being personal client devices of a same user.

A fast run of ad impressions may comprise a set of ad impressions that occur within a relatively short span of time. An ad impression may be considered “fast” if it occurs within a pre-determined measure of time from at least one other ad impression. A sequential series of fast ad impressions may comprise a fast run. Each ad impression of a fast run occurs within the pre-determined measure of time from another ad impression of the fast run. Thus, a fast run may include no ad impression that occur more than the pre-determined measure of time from at least one other ad impression of the run. An example measure of time defining a fast run may be 60 seconds. The fast run data 332 may indicate one or more fast runs.

A slow run of ad impressions may comprise a set of ad impressions that occur at relatively long time intervals from other ad impressions. An ad impression may be considered “slow” if the time interval between the slow ad impression and the prior ad impression is greater than a pre-determined measure of time and the time interval between the ad impression and the subsequent ad impression is greater than the pre-determined measure of time (or other pre-determined measure of time). For example, a slow run of ad impressions may comprise a plurality of ad impressions that are each more than 60 seconds apart from each other. The pre-determined measure of time defining slow runs may be the same pre-determined measure of time defining fast runs. An ad impression that is not part of a fast run may be considered a slow ad impression. A slow run may comprise a single slow ad impression. The slow run data 334 may indicate one or more slow runs.

The survival analysis 340 is also based on the awareness data 320. The awareness data 320 generally indicates the degree to which users are aware of the subject of an ad campaign. Additionally or alternatively, the awareness data 320 may generally indicate the degree to which users are not aware of the subject. As such, the awareness data 320 may represent a determination that a user is aware and/or a determination that a user is not aware. The awareness data 320 may represent the collective awareness of users and/or the individual awareness of users. For example, the awareness data 320 may be organized by user. For a particular user, the awareness data 320 may comprise one or more indicators of the user's awareness of the subject of the ad campaign. The awareness data 320 further indicates a time at which the awareness data 320 is collected or determined, particularly with respect to each individual user and the user's awareness. For example, the time at which a user submits a response to an awareness survey may be indicated by the awareness data 320. It is noted that in some aspects a survey may be presented to different users at different times. The users, likewise, may submit their survey responses at different times. In other aspects, a survey may be presented to all users at the same time.

“Awareness” of the subject of an ad campaign may refer to one or more associations between a user and the subject of the ad campaign. For example, if a user recognizes or has heard of the subject, the user may be considered aware of the subject. As another example, if the user is also able to indicate further details (e.g., the nature of the product, a promoted feature, etc.) regarding the subject, the user may be considered aware, as opposed to the user merely having heard the name of a product but being unable to identify the product or what it does. As yet another example, awareness may require an affirmative identification of the subject in response to some prompt, such as a survey question. As another example, awareness may require that the user have a positive opinion of the subject. The awareness data 320 may indicate the awareness as a binary parameter: the user is aware or not aware. Or the awareness data 320 may be indicated by more than two values, such as “not aware,” “somewhat aware,” and “fully aware.” Awareness of the subject of an ad campaign may be an agreed-upon metric defined by an ad provider or advertiser associated with the ad campaign.

The awareness data 320 may correspond in one or more aspects with the sample impression data 310. The awareness data 320 may correspond, at least in part, with the sample impression data 310 with respect to users—at least some users represented in the sample impression data 310 are also represented in the awareness data 320 and vice versa. In some cases, the users represented in the awareness data 320 are limited to those users that are registered members of the panel. For example, the awareness of co-habitants of the registered user may be un-indicated in the awareness data 320. The awareness data 320 may also correspond with the sample impression data 310 with respect to time—there is at least some overlap between the period of time represented in the sample impression data 310 and the period of time represented in the awareness data 320.

Awareness of a subject of an ad campaign may be a metric, at least in part, going to an effectiveness of an ad campaign. The awareness data 320 may reflect awareness only with respect to a portion of the overall ad campaign. For example, the awareness data 320 may reflect the awareness of the subject of the ad campaign through only a fraction of the full duration of the ad campaign and/or for only a fraction of all users that viewed or potentially viewed an add impression of the ad campaign. The covered time period and users reflected in the sample impression data 310 may be similarly limited. Thus, the awareness data 320 and corresponding sample impression data 310 for the sampled portion of the ad campaign may be used to estimate the awareness for the entire (or at least a greater portion of) ad campaign. In some cases, the sample impression data 310 and awareness data 320 may cover an entire ad campaign but are used instead to determine an effectiveness estimate for a subsequent, related ad campaign. The subsequent ad campaign may have the same subject as a present ad campaign, for example.

The awareness data 320 may comprise survey data 322 and/or activity monitoring data 324. The survey data 322 may indicate awareness data that is determined via surveys of users. For example, one or more users implicated in the sample impression data 310 may be each provided a survey that queries the awareness of the respective user to the subject of the ad campaign. The survey may be provided to registered users of the panel or to only registered users of the panel. The surveys may be provided via a panel application voluntarily installed on a panel client device by a panel member.

Additionally or alternatively, the awareness data may comprise activity monitoring data 324. The activity monitoring data 324 may indicate user interactions with an ad. A user's interactions with an ad may be correlated with an awareness of the user to the subject of the ad campaign. For example, when a user clicks on an ad and is taken to a webpage associated with the ad, the user may be considered aware of the subject of the ad campaign. The activity monitoring data 324 may also indicate other online activity that is not necessarily reliant upon direct interaction with an ad. For example, a user may independently visit a webpage associated with the ad. For instance, the user may view the ad on one tab or window of a web browser and visit a webpage associated with the ad in another tab or window of the web browser. As another example, the user may view the ad and then visit an unaffiliated online store (e.g., Amazon.com) to view or purchase the product or service indicated in the ad. The activity monitoring data 324 may be determined from data collected by a panel application installed on a registered user's client device. The activity monitoring data 324 may be determined by monitoring network traffic associated with ad delivery, such as by the panel application or an upstream router or network device. Thus there may be some overlap between the sample impression data 310 and the activity monitoring data 324 and/or the activity monitoring data 324 may be derived from the sample impression data 310.

The survival analysis 340 may comprise determining a generalized counting and inter-arrival survival distribution, which may estimate the impact to ad impression effectiveness due to otherwise-associated ad impressions occurring on personal devices as well as shared client devices and/or the impact of the varying time intervals between ad impressions (e.g., fast runs versus slow runs) to ad impression effectiveness. Depending on configuration, the survival analysis 340 may potentially treat a determination of awareness as an event of interest. In one embodiment, the survival analysis 340 considers “not aware” as the initial state of awareness for a user and an event of interest may include determining that the user is aware of the subject of the ad campaign. In another embodiment, the survival analysis 340 considers “aware” as the initial state of awareness for a user and the event of interest may include determining that the user is not aware of the subject of the ad campaign. Inter-arrival times of ad impressions may refer to a time period between sequential ad impressions, such as sequential ad impressions on a single client device and/or associated with a single user.

The survival analysis 340 may be performed based on the sample impression data 310, the awareness data 320, and/or the timing data 330. For example, for each user of a plurality of users (e.g., the panel of registered users), data is provided as input to the survival analysis 340 and indicates one or more ad impressions associated with the user, the timestamp of each ad impression of the one or more ad impressions, and the awareness (or lack thereof) of the user to the subject of the ad campaign. The one or more ad impressions associated with a particular user may comprise ad impressions viewed by or intended to be viewed by the particular user but may also comprise ad impressions viewed by or intended to be viewed by other users associated with the particular user, such as users sharing a residence with the particular user.

The noted one or more ad impressions, timestamps, and awareness may be with respect to a time period. That is, the noted one or more ad impressions, timestamps, and awareness may be considered “observed” during the time period, subject to any censoring. The start of the time period may coincide with the start of the ad campaign or with a first ad impression. In the former case, the start of the time period may be static and common to the plurality of users. In the latter case, the start of the time period may be different across the plurality of users. The time period may end at a specified ending event. In some embodiments, the end of the time period may correspond with the time at which the awareness of a user is determined, such as the time at which an awareness survey is provided to the user or the response to an awareness survey is received from users. In this case, the end time may differ across the plurality of users. In other embodiments, the end of the time period may correspond with the end of the ad campaign or other fixed time. A fixed end time may be apt when the awareness is determined based on monitoring for online activity that indicates or suggests that a user is aware of the subject of the ad campaign.

With regard to censoring data associated with a user (e.g., portions of the input sample impression data 310, awareness data 320, and timing data 330 associated with a user), if no event of interest for the user is observed within or at the end of the time period designated for the survival analysis 340, such data may be censored. For example, in an embodiment in which “aware” is deemed the initial awareness state of a user, if a user indicates in a survey that the user is (still) aware of the subject of the ad campaign, the portions of the sample impression data 310, awareness data 320, and timing data 330 associated with the user and covering the time period may be censored. In another embodiment in which the user is deemed to be initially “unware,” if there is no indication (e.g., via monitoring online activity of the user) that the user is aware of the subject of the ad campaign by the end of the designated time period, the portions of the sample impression data 310, awareness data 320, and timing data 330 associated with the user and covering the time period may be censored.

The survival analysis 340 may be performed with respect to n users, wherein an i^{th} user is one of the n users. One or more runs of ad impressions associated with an i^{th} user are determined. A run may be classified as a fast run or a slow run. A censor indicator dᵢ (referred to below in Eqs. (5), (6), (8), and (9)) is equal to 0 when no event is observed at the start of an interval and the observation is censored. The censor indicator dᵢ is equal to 1 when the observation is observed.

For each of n users, the distribution of inter-arrival times follows a Weibull type model. The n users may comprise those users to whom a survey is provided and/or those users that submit a reply to the survey. The n users may comprise those users represented in the awareness data 320. The data comprises i∈{1, . . . , n} users each with j∈{1, . . . , m} runs of the fast or slow type. The slow ad impressions are accumulated prior to the start of the next interval, such as an interval corresponding to a fast run of ad impressions. The number of slow and/or fast ad impressions may be accumulated according to client device and/or client device type. If the event (i.e., an indication of awareness of the subject) is recurrent, such as may be the case with online activity monitoring, it is accumulated in k. The total time for each user is the sum of inter-arrival times. The model can use the total time in slow and/or fast runs in each of the respective mixture distributions. Or the model can be estimated with the proportion of time in fast and/or slow runs relative to the overall total time expressed as the summation of time spent in fast and slow runs.

The survival analysis 340 may include determining one or more survival functions, one or more hazard functions, one or more likelihood functions, and/or one or more related functions that consider, inter alia, a cadence of ad impressions over an observation period, such as a cumulative time in fast runs over an observation period.

A survival function may include a covariate expression given by a which is modified to include hierarchal intercepts and a scaling parameter to adjust a short impression effect. Such a survival function may be written according to Eq. (2) below.

$${S}_{m} ( {t}_{i} , {x}_{i} \vert \cdot ) = exp [ - {\sum }_{j = 1}^{{n}_{i}} {{Ψ}_{m}^{k - 1} ( \frac{{x}_{ij}}{{σ}_{im}} )}^{{γ}_{m}} ( 1 + φ {t}_{ijm} + {γ}_{m} \frac{φ {x}_{ijm}}{{γ}_{m} + 1} ) ] \qquad Eq . ( 2 )$$

The index j∈{1, . . . , m} specifies the long and short inter-arrival times such that m∈{l, s}. In Eq. (2) and elsewhere, t refers, variously, to either a total accumulated time within slow runs or a total accumulated time within fast runs. In the mixture distribution, the first part of the mixture is with respect to slow impressions and thus t in this part refers to the accumulated amount of time in slow runs. Likewise, in the other part of the mixture, t refers to the accumulated amount of time in fast runs. With respect to x, in a configuration in which only one event of interest is to occur (such as when a survey concludes the observation period), x refers to the time from a first ad impression to the time of the event (e.g., the survey). In a configuration in which multiple (i.e., recurring) events are to occur, x refers to the time at which the observation occurred relative to the start of the observation period.

The impression effect may be modeled using a varying user, varying impression type intercept where:

σᵢₘ=exp[−(τₘμᵢₘ+(1+νₘ)β^{T}Z)/γₘ)] Eq. (3)

The β parameter coefficients on the ad impressions are constrained to be the same across fast and slow impression types. The parameter β may relate to the platform of a client device (e.g., desktop, mobile with web browser, mobile with app, or OTT). The parameter ν∈[−1, 1] is equal to 0 when the ad impressions are of the slow type and scales the fast impression coefficients. The model is identified by imposing an order on each user's 2-vector of μ, such that μᵢₛ<μᵢₗ and τ scales the intercept for fast and slow impression types.

The ad impressions are log base 2 transformed to estimate the impact to ad impression effectiveness that would result with each doubling of the number of ad impressions. As such, the parameter β may represent a measure of this estimated impact. ψ penalizes for large number of event occurrences and γ is the scale parameter of the Weibull inter-arrival time distribution. The last component of Eq. (2), (1+ϕtᵢⱼₘ+γₘ(ϕxᵢⱼₘ/(γₘ+1))), indicates the joint effect of total, cumulative, and inter-arrival times, since this component of Eq. (2) includes the total time t spent in an impression type (slow or fast), plus the joint effect of x (a time-to-failure) and time spent in the fast/slow impression types (ϕ) scaled by γ (the “shape” parameter that determines the shape of the Weibull-type distribution).

The above survival function (Eq. (2)) may be used in a mixture model to estimate the joint effect of short and long inter-arrivals impression times. The mixture model is a linear combination of S_{c}(tᵢ|·) such that the total survival is:

S(tᵢ, χᵢ)=λSₜ(tᵢₗ, χᵢ|·)+(1−λ)Sₛ(tᵢₛ, χᵢ|·) Eq. (4)

In Eq. (4), λ is the mixture parameter giving the attribution weight to each inter-arrival time process. Furthermore, the parameters of the two survival functions shown in Eqs. (2) and (4), respectively, can be joint constrained to be equal or freely estimated.

The density function may derive from the survival function shown in Eq. (2), which itself may be used with Eq. (4). The conditional density of x given the total time t may be expressed in the following Eq. (5).

$$- \frac{{dS}_{e} ( x \vert t , \cdot )}{dx} = f ( x \vert t , \cdot ) = exp [ - {( \frac{x}{σ} )}^{γ} {Ψ}^{k - 1} ( 1 + φ t + \frac{γ x φ}{γ + 1} ) ] ( \frac{γ}{σ} ) {( \frac{x}{σ} )}^{γ - 1} {Ψ}^{k - 1} ( 1 + φ t + φ x ) \qquad Eq . ( 5 )$$

Under non-informative censoring, the likelihood function for each inter-arrival process is written according to Eqs. (6) and (7) below, where the likelihood function is incremented by the instantaneous effect f (x|t) when the event occurs and the survival function otherwise.

$$\begin{matrix}{L}_{c} ( {t}_{i} \vert \cdot ) = {\prod }_{j = 1}^{m} {{f}_{c} ( {x}_{j} \vert {t}_{j} , \cdot )}^{{d}_{j}} {{S}_{c} ( {t}_{j} , {x}_{j} \vert \cdot )}^{1 - {d}_{j}} & Eq . ( 6 ) \\ L ( {t}_{i} \vert \cdot ) = λ {L}_{l} + ( 1 - λ ) {L}_{s} & Eq . ( 7 )\end{matrix}$$

The log likelihood for all users is indicated in Eqs. (8) and (9) below.

$$\begin{matrix}{l}_{m} ( {t}_{i} , {x}_{i} \vert \cdot ) = d \{ - {( \frac{x}{σ} )}^{γ} {Ψ}^{k - 1} ( 1 + φ t + \frac{γ x φ}{γ + 1} ) log [ ( \frac{γ}{σ} ) {( \frac{x}{σ} )}^{γ - 1} {Ψ}^{k - 1} ( 1 + φ t + φ x ) ] \} + ( 1 - d ) \{ - {{Ψ}^{k - 1} ( \frac{x {\vert}_{ij}}{σ} )}^{γ} ( 1 + φ {t}_{ij} + \frac{γ x φ}{γ + 1} ) \} & Eq . ( 8 ) \\ {l}_{m} ( {t}_{i} , {x}_{i} \vert \cdot ) = {S}_{m} ( {t}_{i} , {x}_{i} ) \{ d log [ ( \frac{γ}{σ} ) {( \frac{x}{σ} )}^{γ - 1} {Ψ}^{k - 1} ( 1 + φ t + φ x ) ] + ( 1 - d ) \} & Eq . ( 9 )\end{matrix}$$

The final log likelihood is a weighted survival function. When the event (i.e., an indication of awareness or non-awareness) occurs, the survival function is scaled by the log Weibull-like density function, else the log likelihood equals the survival function shown in Eq. (4). Determining or estimating the survival function and/or the various parameters thereof may be performed according to Hamiltonian Monte Carlo (HMC) in a Bayesian framework.

Accordingly, the model 354 is determined based on the survival analysis 340. The model 354 may be determined, at least in part, based on the above-noted survival function(s), likelihood function(s), and/or other function(s). The survival function(s) and likelihood function(s), and/or other function(s) (or other aspect of the survival analysis 340) may be based on ad impression timing that is organized into fast runs (i.e., a series of fast ad impressions) and slow runs (i.e., individual slow ad impressions temporally distant from any other ad impressions). The model 354 may more particularly be based on the survival function(s), likelihood function(s), and/or other function(s) that consider the cumulative time in fast runs at each ad impression. The model 354 may be further based on aspects of ad activity relating to multiple client devices as well as the types of those client devices and the circumstances of their use. For example, the model 354 may be based on an indication that a client device is a desktop device, a mobile device using a web browser, a mobile device using an app, or an OTT device.

The model 354 includes one or more factors 356 that may be applied to various characteristics of other (e.g., later) ad impression data to determine, at least in part, the effect that those ad impressions have on users' (individually or collectively) awareness of the subject of the ad campaign and/or an estimate of an effectiveness of the ad campaign. The model 354 and/or factors 356 may cause one or more ad impressions indicated in the other ad impression data to be weighted with respect to the influence that the ad impression has on awareness and/or ad campaign effectiveness.

The factors 356 may relate to and be applied to various characteristics of ad impression data associated with the relative timing of ad impressions (e.g., timing data indicating the slow runs and fast runs represented in the ad impression data). Thus the timing of ad impressions, particularly as relating to fast runs and slow runs, may be one basis according to which later ad impressions may be evaluated as to the influence or estimated influence that these later ad impressions have on awareness and/or overall effectiveness of the ad campaign.

In addition, the factors 356 may relate to and be applied to ad impression data associated with shared client devices or other data indicating or suggesting that one or more ad impressions associated with a registered user are viewed by other users. Thus ad impression data indicating or suggesting that a user, other than the registered user, viewed one or more ad impressions may be yet another basis by which later ad impression data may be evaluated to determine the impact that shared devices, etc. have on awareness and/or the effectiveness of an ad campaign.

According to the above example indicated by Eqs. (1) through (9) discussed in relation to the survival analysis 340, the model 354 may comprise up to six factors 356. The disclosure, however, is not so limited and the model 354 may comprise any number of factors 356.

The factor ψ indicates an effect caused by recurrent events, such as multiple indications in the activity monitoring data 324 that a user is aware of the subject of the ad campaign. For example, the factor ψ may reflect that a greater number of recurrent events (e.g., indications of awareness or non-awareness) occurred within a sample time period. In a configuration in which a recurrent event indicates an awareness, such as clicking on an ad, a greater number of recurrent events may indicate a corresponding increase in the effectiveness of the ad campaign and/or associated ad impressions. With respect to the above-described survival functions (which treat an initial state of a user as “aware”), a value of ψ between 0 and 1 may cause a decrease in survival with each additional event. A value of ψ greater than 1 may cause an increase in survival with each additional event. A value of ψ equal to 1 may result in no effect to survival for each additional event. The ad impressions indicated in the second impression data 362 may be weighted, with respect to effectiveness, according to the number of recurrent events indicated in the second impression data 362 and the factor ψ.

The factor ψ may be not determined or may be irrelevant in embodiments in which the survival analysis 340 (and/or the overall study performed) is not configured to allow recurrent events. This may be the case in the described example in which user awareness is determined based on the survey data 322. In this example, the period of time considered for the survival analysis 340 ends when the survey is administered, thus precluding any recurrent events. Further in this example, the factor ψ may be set to 1 for Eqs. (2), (5), (8), and (12).

The factor ν indicates an effect to ad campaign effectiveness caused by fast runs and/or fast ad impressions. The effect to ad campaign effectiveness indicated by the factor ν may be with respect to client device type. The factor v may adjust the weight given to the factor β and/or sub-factors Desktop_{β}, Mobile Web_{β}, Mobile App_{β}, and OTT_{β} for fast runs and/or fast ad impressions. The factor ν may refer to a cumulative time of fast runs and/or a total number of fast ad impressions within an observed time. The factor ν may indicate a relative effect of fast runs/impressions to slow runs/impressions with respect to ad campaign effectiveness. The factor ν may be a positive or negative value. A negative value of ν may indicate that fast runs have a lesser effect than slow runs. A position value of ν may indicate that fast runs have a greater effect than slow runs.

The factor ϕ indicates an effect of time spent within fast and slow runs. In an embodiment, the factor ϕ (which may be referred to particularly as ϕₛ this case) may indicate an effect of time spent within just fast (i.e., short) runs. In another embodiment, the factor ϕ (which may be referred to particularly as ϕₗ in this case) may indicate an effect of time spent within just slow (i.e., long) runs. A greater value of ϕ (e.g., a greater amount of time spent within fast runs, within just slow runs, or within both fast and slow runs, as the case may be) may correspond to a greater effectiveness of an ad campaign and/or ad impressions thereof. In some embodiments, the factor ϕ may represent a proportion of time spent within just long runs, within just short runs, or within both long and short runs (as the case may be) relative to a total time (e.g., a total time of observation). A positive value of ϕ may indicate an increase to effectiveness while a negative value of ϕ may indicate a decrease to effectiveness. The ad impressions indicated in the second impression data 362 may be weighted, with respect to effectiveness, according to the time spent within just short runs, within just long runs, or within both short and long runs (as the case may be) and the factor ϕ.

The factor θ indicates an effect attributable to slow runs and/or slow ad impressions. The factor θ may refer to a cumulative count of slow ad impressions during an observed time period and/or a cumulative time spent within slow runs during an observed time period. For example, the factor θ may indicate that slow ad impressions are twice as effective as fast ad impressions. A value of the factor θ less than 1 may indicate that slow ad impressions are more effective, a value of the factor θ greater than 1 may indicate that fast ad impressions are more effective, and a value of the θ may indicate that slow and fast ad impressions are equally effective. The factor θ may be considered in combination with the factor ν. For example, (1−θ)×(1+ν) may reflect relative weights given to slow ad impressions and fast ad impressions.

The factor γ may serve as a “scale” parameter and be expressed as a sub-factor γₛ to refer to ad impressions in a fast (i.e., short) run and as a sub-factor γₗ to refer an ad impression forming a slow (i.e., long) run. A γ factor or sub-factor may indicate the “spread” of a respective survival distribution. Sub-factors γₛ and γₗ may be compared to determine the degree to which the two distributions (i.e., the distribution for long runs and the distribution for fast runs) are spread from one another.

The factor β indicates the effect of ad impressions based on the types of client device (i.e., the “platform”) represented in associated ad impression data. That is, factor β indicates the effect attributable to the type of client device used to access online content comprising an ad impression. For example, an effectiveness of an ad impression may be weighted based on the type of client device being used to cause the ad impression. A type of client device may refer to a hardware configuration, a software configuration, an associated media delivery system, or any combination thereof. The factor β may comprise one or more sub-factors, with each sub-factor being associated with a type of client device. For example, a sub-factor of the factor β (Desktop_{β}) may reflect ad impressions implemented on a desktop device. Another example sub-factor of the factor β (Mobile Web_{β}) may reflect ad impressions implemented on a web browser running on a mobile device. Another example sub-factor of the factor β (Mobile App_{β}) may reflect ad impressions implemented on an “app” (excluding web browsers) running on a mobile device. Yet another example sub-factor of the factor β (OTT_{β}) may reflect ad impressions implemented via OTT media services.

A lower value, particularly a negative value, of the factor β associated with a given device type may correspond with an increased effect to ad campaign effectiveness resulting from ad impressions made via client devices of the given device type. For example, a negative value of OTT_{β}may indicate an increased probability that a user is made aware of the subject of an ad campaign when an ad impression is made via an OTT device. Conversely, a higher value, particularly a positive value, of the factor β associated with a given device type may correspond with a decreased effect to ad campaign effectiveness resulting from ad impressions made via client devices of the given device type. For example, a positive value of Desktop_{β} may indicate a decreased probability that a user is made aware of the subject of an ad campaign when an ad impression is made via a desktop device. The ad impressions indicated in the second impression data 362 may be weighted, with respect to effectiveness, according to the types of the client devices used to cause those ad impressions and the factor β and/or one or more respective sub-factors of the factor β.

The effectiveness estimate 360 for an ad campaign (and/or ad impressions thereof) associated with the second impression data 362 is determined based on the model 354 (e.g., the factors 356) and the second impression data 362. The second impression data 362 may be similar in some aspects to the sample impression data 310. The second impression data 362 may be similar to the sample impression data 310 with respect to the types and/or sources of data represented. For example, the second impression data 362 may be derived from and/or comprise panel data, tag data, and/or third party data.

The effectiveness estimate 360 generally may be an estimate of user awareness (or other metric) to the subject of the ad campaign. The effectiveness estimate 360 may be determined by applying the model 354 to the second impression data 362. The second impression data 362 may be provided to the model 354 as input and the model 354 may be used to determine the effectiveness estimate 360. For example, the effectiveness estimate 360 may be determined by applying one or more of the factors 356 to the second impression data 362.

Applying a factor 356 to the second impression data 362 may comprise determining one or more attributes of the second impression data 362 and weighting those one or more attributes based on the factor(s) 356 that corresponds to those one or more attributes. The effectiveness estimate 360 may be based, at least in part, on the weighted one or more attributes. For example, the attributes of the second impression data 362 relating to device type may be weighted according to the factor β. Weighting one or more attributes of the second impression data 362 may comprise modifying or determining, based on the corresponding factor(s) 356, the degree to which said one or more attributes influence effectiveness.

The second impression data 362 may reflect online ad activity associated with one or more ad impressions of the evaluated ad campaign. The online ad activity reflected in the second impression data 362 may be that of a subset of users of a larger body of users that had some interaction with one or more ad impressions of the ad campaign. For example, the subset of users whose online ad activity is represented in the second impression data 362 may comprise registered users of a panel (e.g., the panel 105 of FIG. 1). In some instances, the subset of users may include users that are associated with the registered users, such as the other members of a registered user's household. As such, the second impression data 362 may serve as a data sample of the online ad activity of the larger body of users. Applying the model 354 to the second impression data 362 may result in an estimate of effectiveness with respect to the subset of users associated with the second impression data 362. This intermediate effectiveness estimate for the subset of users may be extrapolated to the larger body of users to determine the effectiveness estimate 360. Additionally or alternatively, the online ad activity of the subset of users may be extrapolated to the larger body of users and the model 354 may be applied to this extrapolated online ad activity data to determine the effectiveness estimate 360. In one embodiment, the effectiveness estimate 360 may be with respect to the subset of users rather than the larger body of users. In such an embodiment, the effectiveness estimate 360 by not be based on an extrapolation of the online ad activity data of the subset of users to the larger body of users.

The ad campaign associated with the effectiveness estimate 360 may be the same ad campaign represented in the sample impression data 310 and referred to in the awareness data 320. The second impression data 362 may represent a continuation of the initial sample impression data 310 in that the sample impression data 310 may be limited to ad impressions and other online ad activity that occurred within the observed time (e.g., up to the time of the survey) used by the survival analysis 340. For example, the sample impression data 310 may cover an initial portion of the ad campaign and the second impression data 362 may cover a later portion of the ad campaign. In another embodiment, the ad campaign associated with the effectiveness estimate 360 may be a second ad campaign, distinct from that associated with the sample impression data 310 and awareness data 320. For example, the second ad campaign may have the same or similar subject as that of the initial ad campaign. Additionally or alternatively, the initial ad campaign and the second ad campaign may be associated with a same ad provider or advertiser. The second impression data 362 in this embodiment may be likewise associated with the second ad campaign.

The effectiveness estimate 360 may be output as the report 366. The report 366 may be realized as an electronic communication or document, such as an email or text document, or as a physical document. The report 366—and the effectiveness estimate 360 in general—may be used to determine various parameters for implementing other portions or stages of the same ad campaign or a later, associated ad campaign. For example, future ad impressions on a particular type of client device (“platform”) may be reduced based on an indication in the report 366 that ad impressions on that particular type of client device afford little impact to ad campaign effectiveness.

FIG. 4 illustrates an example process 400 for determining one or more factors (e.g., the factors 356 of FIG. 3) relating to online ad delivery. The one or more factors may be determined using one or more survival analysis techniques (e.g., the survival analysis 340 of FIG. 3). The determined one or more factors or subset thereof may be used to weight corresponding attributes of subsequent online ad activity (e.g., the second impression data 362 of FIG. 3). Additionally or alternatively, the one or more factors or subset thereof may be used to weight one or more ad impressions of the subsequent online ad activity. The weighted attributes or ad impressions of the subsequent online ad activity may be used to determine an estimate of the effectiveness (e.g., the effectiveness estimate 360 of FIG. 3) of an associated ad campaign or portion thereof.

At step 402, impression data (e.g., the sample impression data 310 of FIG. 3) indicative of online ad activity associated with the ad campaign is received. The impression data may reflect online activity associated with a portion of the ad campaign. The impression data may be associated with a plurality of ad impressions for the ad campaign. As such, the online ad activity indicated in the impression data may reflect aspects of ad delivery of the plurality of ad impressions. The impression data may be limited to a pre-determined period of time, which may be regarded as the “observed time” for purposes of the survival analysis. For example, the online ad activity reflected in the impression data may indicate those ad impressions or attempts thereof that occurred during the pre-determined period of time.

Further, the impression data may be associated with a subset of users. The subset of users may be a subset of a larger body of users having some interaction with one or more ad impressions of the ad campaign. For example, the subset of users may comprise the registered users of a sample panel (e.g., the panel 105 of FIG. 1) that have allowed for the registered users' online activity to be recorded and reported. In some cases, the online ad activity indicated in the impression data may be associated with other users that are associated with a registered user, such as co-habitants of the registered user or users sharing an IP address with the registered user. Online ad activity indicated in the impression data may be associated with respective client devices (e.g., the client devices 106 of FIG. 1) and/or the corresponding client device types (e.g., the “platform”). The impression data may indicate online ad activity on a device-by-device basis and/or a type-by-type basis. A client device and/or client device type may be designated in the impression data as a personal client device of a registered user or a shared client device associated with a registered user, as examples.

As noted, the impression data may indicate online ad activity associated with ad impressions of the ad campaign. For example, the impression data may indicate that an ad was requested, the requesting client device and/or the client device's type, the user associated with the client device, the webpage that initiated the ad request, whether the ad was delivered to the client device, the times at which the ad was requested and/or delivered, whether the impression of the ad occurred, and whether the ad impression was rendered or otherwise exposed to the user.

The impression data may include user data, such as demographic information. The demographic information may be with respect to a registered user associated with the client device requesting the ad. The demographic information may include, for example, a user's age, gender, race, income, address or other location indicator, and occupation. User data may include information about a user's browsing or online activity habits, such as an average time spent online or times of day that a user is online.

The impression data may include panel data (e.g., the panel data 312 of FIG. 3) that is determined by virtue of a user's registration as part of the panel. For example, a registered user's client device may be configured with an application that records and reports online ad activity occurring on the client device. As another example, a registered user may provide demographic information and/or client device information during panel registration. The impression data may include tag data (e.g., the tag data 314) that is based on a tag or other indicator associated with the ad impression that causes a message to be sent that indicates that the ad was requested and/or delivered. Further, the tag data may be based on a 1×1 pixel in the ad that causes a network location redirect indicating that the ad impression occurred. The impression data may include third party data (e.g., the third party data 316 of FIG. 3) in which a third party (e.g., a party distinct from the publisher and advertiser) reports that the third party received a request for an ad and the third party delivered the ad to the requesting client device.

At step 404, awareness data (e.g., the awareness data 320 of FIG. 3) indicative of awareness of the subject of the ad campaign is received. The awareness data may indicate that a user is aware of the subject of the ad campaign or that a user is not aware of the subject of the ad campaign. Positive awareness of the subject of the campaign may tend to evidence, at least in part, that the ad campaign or relevant portion of the ad campaign is effective. The users represented in the awareness data may be registered users of the panel, for example.

The awareness data may correspond in one or more aspects with the received impression data. For example, the awareness data may indicate the awareness of one or more users and the impression data may indicate the online ad activity of at least the same one or more users. As such, there may be at least some overlap between the users represented in the awareness data and the impression data. As another example, the awareness data and the impression data may overlap, at least in part, with respect to time. The pre-determined or observed period of time discussed in relation to the impression data of step 402 may be based on a time that awareness is determined (or vice versa). For example, the pre-determined period of time may terminate at the time that awareness is determined, such as when an awareness survey is administered.

The awareness data may be based on a survey querying whether a recipient user is aware of the subject of the ad campaign or is not aware of the subject of the ad campaign (e.g., the survey data 322). The users given the survey may be registered users of the panel. Additionally or alternatively, the awareness data may be based on monitoring the online activity of a subject user (e.g., the activity monitoring data 324). The online activity may be monitored for online activity that indicates at least some degree of awareness of the subject of the ad campaign. For example, clicking an ad impression associated with the ad campaign may indicate that the user is aware of the subject of the ad campaign.

At step 406, one or more timing characteristics associated with the online ad activity indicated in the impression data (e.g., the timing data 330 of FIG. 3) are determined. The one or more timing characteristics may be based on the impression data, such as data indicating the times that ad impressions occurred. The one or more timing characteristics may indicate one or more fast runs and respective constituent fast ad impressions (e.g., the fast run data 332 of FIG. 3). A fast run may comprise a sequence of ad impressions that each occur within a pre-determined unit of time from at least one other ad impression of the fast run. The one or more timing characteristics may indicate one or more slow runs and respective slow ad impressions (e.g., the slow run data 334 of FIG. 3). A slow run may comprise an ad impression that occurs outside of a pre-determined unit of time (e.g., the same pre-determined unit of time defining a fast run) from any other ad impression. The fast and/or slow runs of ad impressions may be indicated on a user-by-user basis. The fast and/or slow runs of ad impressions may be additionally or alternatively indicated on a client device and/or client device type basis.

The one or more timing characteristics may indicate the relative timing of ad impressions indicated in the impression data. The one or more timing characteristics may indicate the relative timing of ad impressions associated with a user. For example, the one or more timing characteristics may indicate a quantity of ad impressions of a fast run of ad impressions. The one or more timing characteristics may indicate an elapsed time duration of a fast run. The one or more timing characteristics may indicate an aggregate elapsed time durations of two or more fast runs. The one or more timing characteristics may indicate an elapsed time duration between a first fast run and a second fast run. As another example, the one or more timing characteristics may indicate a quantity of slow ad impressions. The one or more timing characteristics may indicate time durations between two slow ad impressions, between a slow ad impressions and a fast run, and/or between two fast runs.

Additionally or alternatively, the impression data may indicate ad impressions performed in association with a first device type and ad impressions performed in association with a second device type. The impression data may indicate the relative timing between the ad impressions associated with the first device type and the ad impressions associated with the second device type. The impression data may indicate the quantity of ad impressions associated with the first device type and the quantity of ad impressions associated with the second device type.

At step 408, a survival analysis (e.g., the survival analysis 340 of FIG. 3) is used to determine, based on the impression data and the awareness data, the one or more factors. The one or more factors may be determined, using the survival analysis, further based on the one or more timing characteristics.

The survival analysis may comprise a survival algorithm, such as a survival function, and the one or more factors may be determined using the survival function. Additionally or alternatively, the survival analysis may comprise a hazard function and/or a cumulative hazard function and the one or more factors may be determined using the hazard function and/or cumulative hazard function. The hazard function and/or the cumulative hazard function may be with respect to a user. Additionally or alternatively, the survival analysis may comprise a likelihood function and the one or more factors may be determined using the likelihood function. The likelihood function may be with respect to a user or multiple users (e.g., the panel of users). The one or more factors may be determined by performing a fit of the one or more factors to the survival function and/or likelihood function.

For example, the one or more factors may be based on aspects of fast runs of ad impressions indicated in the impression data and/or one or more timing characteristics, such as the respective or aggregate durations of fast runs, the respective or aggregate quantities of fast ad impressions of fast runs, and the time durations between fast runs. The one or more factors may be based on aspects of slow ad impressions indicated in the impression data, such as the quantity of slow ad impression and the occurrence times between a pair of slow ad impressions, between a slow ad impression and a fast run of ad impressions, and/or between a pair of fast runs of ad impressions.

For example, the one or more factors may be based on aspects of ad delivery associated with client device type, such as respective quantities of ad impressions associated with two or more client device types and/or the respective relative timing between ad impressions associated with two or more client device types. One or more factors may be associated with, at least in part, the noted aspects of ad delivery associated with fast runs, slows runs, and varying client device types. One or more factors may be further associated with, at least in part, the observed time duration reflected in the impression data, awareness data, and/or one or more timing characteristics. One or more factors may be yet further associated with recurrent events, such as determinations of awareness.

The one or more factors may be indicative, at least in part, as to the degree of influence or effect that one or more attributes of additional online ad activity have on the effectiveness (e.g., awareness of the subject) of the ad campaign or portion thereof. The additional online ad activity (and associated ad impressions) may be associated with a second portion of an ad campaign while the online ad activity indicated in the initial impression data may be associated with a first portion of the ad campaign.

As an example, the one or more factors may include a factor indicating an effect caused by recurrent events, such as multiple indications that a user is aware of the subject of the ad campaign. Further, a factor may indicate an effect relating to the cumulative elapsed time duration of fast runs. A factor may indicate an effect relating to the quantity of fast ad impressions over one or more fast runs. A factor may indicate an effect relating to the total observation time, such as the time corresponding to the initial impression data and/or awareness data. A factor may indicate an effect relating to the duration of time between slow ad impressions. A factor may indicate an effect relating to types of client devices, such as the quantity and/or relative timing of slow ad impressions per device type. The one or more factors may be applied to additional impression data associated with the ad campaign to determine an estimate of the effectiveness of the relevant portion of the ad campaign as to achieving awareness of the subject of the ad campaign.

At step 410, a report (e.g., the report 366 of FIG. 4) is generated that indicates the one or more factors. The report may be realized as a physical report, such as a paper report. Additionally or alternatively, the report may be in the form of an electronic communication, such as an email or text document.

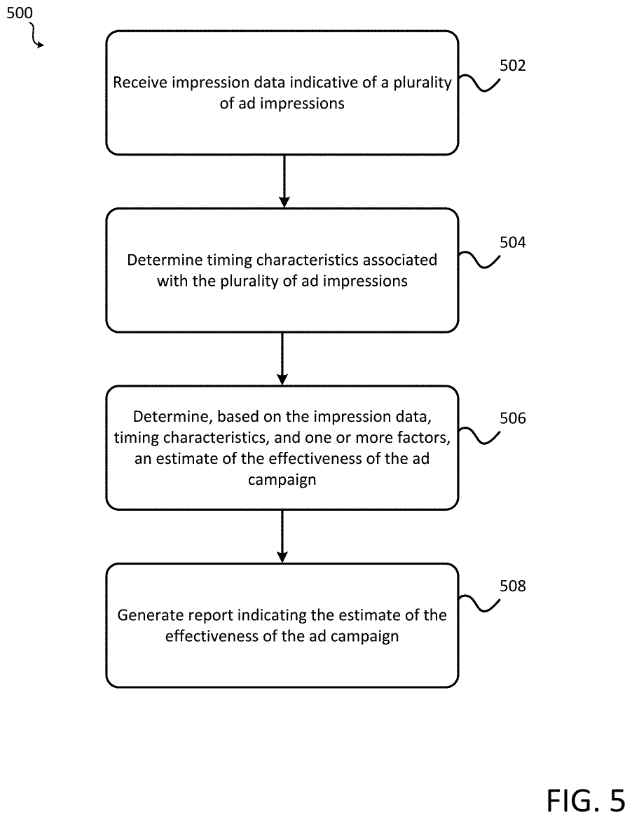

FIG. 5 illustrates an example process 500 for determining an estimated effectiveness of at least a portion of an ad campaign. The ad campaign may be that discussed in relation to FIG. 4. The process 500 of FIG. 5 may form a continuation of the process 400 of FIG.

4.

At step 502, impression data (e.g., the second impression data 362 of FIG. 3) indicating a plurality of ad impressions is received. The received impression data of step 502 may indicate ad impressions occurring subsequent to those ad impressions discussed in relation to step 402 of FIG. 4. Additionally or alternatively, the received impression data of step 502 may indicate ad impressions that occurred contemporaneously with the ad impressions referred to in step 402 of FIG. 4, but rather indicate ad impressions associated with other users instead of those users associated with the ad impressions referred to in step 402 of FIG. 4. For purposes of discussing the process 500, the impression data indicated in step 402 of FIG. 4 shall be referred to as first impression data and the impression data indicated in step 502 shall be referred to as second impression data.

The second impression data may share some characteristics of the first impression data of step 402 of FIG. 4. For example, the second impression data may generally indicate online ad activity. The indicated online ad activity may occur over an observed period of time and may reflect ad impressions associated with a set of users, such as a panel of users (e.g., the panel 105 of FIG. 1). This panel of users may be the same, at least in part, as the panel of users from which the first impression data is based. In addition, the ad impressions indicated in the second impression data may be associated with various types of client devices. For example, some ad impressions may be associated with a first device type and some other ad impressions may be associated with a second device type. Some client device types may be classified as personal devices and other client device types may be classified as shared devices.

The second impression data may indicate the various steps (and aspects thereof) involved in online ad delivery, such as the request for an ad by the client device, the delivery of the ad by the ad server, the receipt of the ad at the client device, and the rendering and/or exposure of the ad at the client device to the user. The second impression data may include user data, such as demographic information or data describing a user's online habits. The second impression data may include information on a client device, such as the type of the client device and whether it is classified as a shared device or a personal device. The second impression data may include panel data (e.g., similar to the panel data 312 of FIG. 3) collected by a panel application installed on a user's client device to capture his or her online activity. The second impression data may include tag data (e.g., similar to the tag data 314 of FIG. 3) derived from a message caused to be sent by a tag included with a delivered ad. The second impression data may include third party data (e.g., similar to the third party data 316 of FIG. 3) captured by a third party distinct from the publisher and advertiser.

At step 504, one or more timing characteristics associated with the plurality of ad impressions indicated in the second impression data are determined. For purposes of discussing the process 500, the one or more timing characteristics of step 504 shall be referred to as the second one or more timing characteristics. The second one or more timing characteristics may be determined based on the second impression data. The second one or more timing characteristics may be organized on a user-by-user basis. The second one or more timing characteristics may be similar (e.g., as to form and types of data) in some aspects to the one or more timing characteristics of step 406 of FIG. 4 and/or the timing data 330 of FIG. 3. The second one or more timing characteristics may indicate the relative timing of the ad impressions indicated in the second impression data. For example, the second one or more timing characteristics may indicate any fast runs of ad impressions (e.g., similar to the fast run data 332 of FIG. 3), including individual and aggregate elapsed time durations of fast runs and the number of fast ad impressions that are part of fast runs. The second one or more timing characteristics may further indicate any slow ad impressions (e.g., similar to the slow run data 334 of FIG. 3), including the number of slow ad impressions and the relative timing between slow ad impressions and/or between a slow ad impression and a prior or subsequent fast run.

The second impression data and/or the second one or more timing characteristics may describe the types of client devices used to perform respective ad impressions. The second impression data and/or the second one or more timing characteristics may indicate slow ad impressions according to client device type. For example, a first set of slow ad impressions may be associated with a first type of client device and a second set of slow ad impressions may be associated with a second type of client device. The form and types of information relating to client device types for the process 500 may be similar to the client device information that may be used to determine the one or more factors of step 408 of FIG. 4.

At step 506, the estimated effectiveness of the ad campaign or portion thereof (e.g., the effectiveness estimate 360 of FIG. 3) is determined based on the second impression data, the second one or more timing characteristics, and one or more factors (e.g., the factors 356 of FIG. 3). The one or more factors may be those determined based on the first impression data and the initial one or more timing characteristics. The one or more factors may be the same or similar as the one or more factors determined in step 408 of FIG. 4.

As indicated above with respect to step 408 of FIG. 4, the one or more factors may include a factor relating to recurrent events (e.g., indications of awareness) within the observed time period. The one or more factors may include a factor relating to the aggregate durations of time of fast runs and a factor relating to the quantity of fast ad impressions of the fast runs. The one or more factors may include a factor relating to the total observation time. The observation time may be that covered by the first impression data or the second impression data. The one or more factors may include a factor relating to the time durations between slow ad impressions, as well as time durations between a slow ad impression and the prior or subsequent fast run and time durations between fast runs. The one or more factors may include a factor relating to the quantity of slow ad impressions, including the quantities of slow ad impressions according to client device type.

The estimated effectiveness of the ad campaign may be determined by applying the one or more factors to the generally corresponding attributes of the ad impressions indicated in the second impression data and/or the second one or more timing characteristics. For example, attributes of the ad impressions may be weighted based on the corresponding factor(s) of the one or more factors. In some instances, ad impressions and/or relevant attribute(s) thereof indicated in the second impression data and/or second one or more timing characteristics may be weighted on an impression-by-impression basis. Thus, an ad impression may be weighted as a whole according to the one or more factors. Additionally or alternatively, the ad impressions may be weighted by subsets of ad impressions, with each subset being weighted separately from other subsets. For example, the ad impressions associated with one user may be weighted separately from the ad impressions associated with another user. In addition to weighting ad impressions according to subsets defined by individual users, ad impressions also may be weighted according to client device type and/or according to groups of users having some commonality (e.g., a common residence, a common IP address, or a common association with a registered user). Additionally or alternatively, the body of ad impressions and/or relevant attribute(s) of the body of ad impressions indicated in the second impression data and/or second one or more timing characteristics may be weighted as a whole instead of each ad impression and/or the relevant attribute(s) of each ad impression being weighted separately.

In an example, the factor relating to the aggregate elapsed durations of time of fast runs may be applied to the aggregate elapsed durations of time of fast runs of the ad impressions indicated in the second impression data and/or the second one or more timing characteristics. In an aspect, naive techniques may be used to determine a default effectiveness metric based on the aggregate elapsed durations of time of the fast runs indicated in the second impression data and/or second one or more timing characteristics. The default effectiveness metric may indicate the degree of impact to ad campaign effectiveness that is otherwise expected to result due, at least in part, to the indicated aggregate elapsed fast run time durations. The default effectiveness metric may be modified (e.g. weighted) based on the associated factor of the one or more factors. In an example, the factor relating to the aggregate elapsed time durations of fast runs may indicate that the aggregate elapsed time durations of fast runs has a lesser effect to ad campaign effectiveness than indicated in the default effectiveness metric. Thus, the default effectiveness metric may be weighted (e.g., downscaled) according to this factor to reflect the lesser effect that aggregate elapsed time durations of fast runs has on ad campaign effectiveness. In other aspects, weighting or other application of the one or more factors to the ad impression(s) and/or relevant attribute(s) may be integrated into a larger analysis (e.g., algorithm(s) and/or function(s)) or other technique to determine an estimate of the effectiveness of the ad campaign.

It is noted that the one or more factors may be ad campaign specific. For example, the one or more factors described herein are based on prior online ad activity associated with the ad campaign and corresponding awareness data reflecting actual user awareness of the subject of the ad campaign. The one or more factors may thus account for the particular circumstances and other variables unique to a specific ad campaign, which is expected to yield a more accurate estimate of effectiveness for this ad campaign. (Such benefit may be likewise realized in estimating ad campaign effectiveness for another ad campaign that is substantially similar to the initial ad campaign.) By contrast, a default effectiveness metric and/or naive technique for determining the same may comprise instead only a generic metric or technique that is not specific to an instant ad campaign.

At step 508, a report (e.g., the report 366 of FIG. 3) is generated that indicates the estimate of the effectiveness of the ad campaign. The report may be realized in a physical form, such as a paper report. The report may additionally or alternatively be in the form of an electronic medium, such as an email or text document.

The dataflow of FIG. 3, the process 400 of FIG. 4 and/or the process 500 of FIG. 5 may be implemented at the content provider 108, the ad provider 102, the analysis network 104, one or more client devices 106, and/or another system or entity. Certain aspects of the content provider 108, the ad provider 102, the analysis network 104, and the client devices 106 of FIG. 1, the webpage 200 of FIG. 2, the dataflow of FIG. 3, and the processes of FIGS. 4 and 5 may be implemented as or using a computer program or set of programs. The computer programs may exist in a variety of forms both active and inactive. For example, the computer programs may exist as software program(s) comprised of program instructions in source code, object code, scripts, executable code or other formats, firmware programs(s), or hardware description language (HDL) files. Any of the above may be embodied on a non-transitory computer readable medium, which include storage devices, in compressed or uncompressed form. Exemplary computer readable storage devices may include conventional computer system random access memory (RAM), read-only memory (ROM), erasable, programmable memory (EPROM), electrically erasable, programmable memory (EEPROM), and magnetic or optical disks or tapes.

Certain aspects the ad provider 102, the analysis network 104, the client devices 106, and the content provider 108 of FIG. 1, the webpage 200 of FIG. 2, the data flow of FIG. 3, and the processes of FIGS. 4 and 5 may utilize or include a computer system, which may include one or more processors coupled to random access memory operating under control of or in conjunction with an operating system. The processors may be included in one or more servers, clusters, or other computers or hardware resources, or may be implemented using cloud-based resources. The processors may communicate with persistent memory, which may include a hard drive or disk array, to access or store program instructions or other data. The processors may be programmed or configured to execute computer-implemented instructions to perform the steps disclosed herein.

While the techniques for determining an estimate of the effectiveness of an ad campaign have been described in terms of what may be considered to be specific aspects, this disclosure need not be limited to the disclosed aspects. Additional modifications and improvements may be apparent to those skilled in the art. As such, this disclosure is intended to cover various modifications and similar arrangements included within the spirit and scope of the claims, the scope of which should be accorded the broadest interpretation so as to encompass all such modifications and similar methods. The present disclosure should be considered as illustrative and not restrictive.

1. A method, comprising:
receiving first data indicative of a first plurality of ad impressions within a first portion of an ad campaign associated with a panel of users;
receiving second data indicative of awareness of a subject of the ad campaign by the panel of users;
determining, based on the first data, a first one or more timing characteristics associated with the first plurality of ad impressions; and
using a survival analysis to determine, based on the first data, the second data, and the first one or more timing characteristics, one or more factors indicative of an estimated effect of one or more attributes of a second plurality of ad impressions to an effectiveness of a second portion of the ad campaign associated with the second plurality of ad impressions.

2. The method of claim 1, further comprising:
receiving third data indicative of the second plurality of ad impressions; and
determining, based on the third data and the one or more factors, an estimate of the effectiveness of the second portion of the ad campaign.

3. The method of claim 2, wherein an attribute of the one or more attributes of the second plurality of ad impressions comprises a second one or more timing characteristics associated with the second plurality of ad impressions, and
wherein the determining the estimate of the effectiveness of the second portion of the ad campaign is further based on the second one or more timing characteristics.

4. The method of claim 2, wherein a timing characteristic of the first one or more timing characteristics is indicative of a relative timing of a subset of ad impressions of the first plurality of ad impressions, wherein the subset of ad impressions is associated with a user of the panel of users.

5. The method of claim 4, wherein the subset of ad impressions comprises a first fast sequence of ad impressions, each ad impression of the first fast sequence of ad impressions occurring within a predetermined unit of time prior to or following at least one other ad impression of the first fast sequence of ad impressions, and
wherein the one or more factors are further based on the first fast sequence of ad impressions.

6. The method of claim 5, wherein the timing characteristic of the first one or more timing characteristics is further indicative of a quantity of ad impressions of the first fast sequence of ad impressions.

7. The method of claim 6, wherein the timing characteristic of the first one or more timing characteristics is further indicative of an elapsed duration of time of the first fast sequence of ad impressions.

8. The method of claim 5, wherein the subset of ad impressions comprises a second fast sequence of ad impressions, each ad impression of the second fast sequence of ad impressions occurring within the predetermined unit of time prior to or following at least one other ad impression of the second fast sequence of ad impressions, and
wherein the one or more factors is further based on the second fast sequence of ad impressions.

9. The method of claim 8, wherein the timing characteristic of the first one or more timing characteristics is further indicative of an aggregate elapsed durations of time of the first fast sequence of ad impressions and the second fast sequence of ad impressions.

10. The method of claim 5, wherein the subset of ad impressions comprises one or more slow ad impressions, each slow ad impression of the one or more slow ad impressions occurring outside of a second predetermined unit of time prior to or following any other ad impression of the subset of ad impressions.

11. The method of claim 10, wherein the timing characteristic of the first one or more timing characteristics is further indicative of a quantity of slow ad impressions of the one or more slow ad impressions.

12. The method of claim 10, wherein the timing characteristic of the first one or more timing characteristics is further indicative of inter-occurrence durations of time with respect to each slow ad impression of the one or more slow ad impressions and respective immediately-prior and immediately-subsequent ad impressions of the subset of ad impressions.

13. The method of claim 4, wherein a first one or more ad impressions of the subset of ad impressions are associated with a first device type and the one or more factors are further based on the association of the first one or more ad impressions with the first device type.

14. The method of claim 13, wherein a second one or more ad impressions of the subset of ad impressions are associated with a second device type and the one or more factors are further based on the association of the second one or more ad impressions with the second device type.

15. The method of claim 14, wherein the one or more factors are further based on a quantity of the first one or more ad impressions associated with the first device type and a quantity of the second one or more ad impressions associated with the second device type.

16. The method of claim 14, wherein the one or more factors are further based on a relative timing between an ad impression of the first one or more ad impressions associated with the first device type and an ad impression of the second one or more ad impressions associated with the second device type.

17. The method of claim 2, wherein the determining the estimate of the effectiveness of the second portion of the ad campaign comprises:
weighting, based on the one or more factors, one or more ad impressions of the second plurality of ad impressions.

18. The method of claim 1, wherein the second data indicative of awareness is based on one or more surveys submitted to the panel of users.

19. The method of claim 1, wherein the second data indicative of awareness is based on monitored online activity associated with a user of the panel of users, the monitored online activity being further associated with the subject of the ad campaign.

20. The method of claim 1, wherein the survival analysis comprises a likelihood function associated with at least one of a likelihood of a user being aware of the subject of the ad campaign and a likelihood of a user being unaware of the subject of the ad campaign.

21. A non-transitory computer readable medium storing instructions that, when executed by one or more processors, effectuates operations comprising:
receiving first data indicative of a first plurality of ad impressions associated with a panel of users, wherein the first plurality of ad impressions are further associated with at least a first portion of an ad campaign;
receiving second data indicative of awareness of a subject of the ad campaign by the panel of users;
determining, based on the first data, a first one or more timing characteristics associated with the first plurality of ad impressions; and
using a survival analysis to determine, based on the first data, the second data, and the first one or more timing characteristics, one or more factors indicative of an estimated effect of one or more attributes of a second plurality of ad impressions to an effectiveness of a second portion of the ad campaign associated with the second plurality of ad impressions.

22. The non-transitory computer readable medium of claim 21, wherein the operations further comprise:
receiving third data indicative of the second plurality of ad impressions; and
determining, based on the third data and the one or more factors, an estimate of the effectiveness of the second portion of the ad campaign.

23. A system comprising at least one processor connected to at least one storage device, the system being configured to:
receive first data indicative of a first plurality of ad impressions associated with a panel of users, wherein the first plurality of ad impressions are further associated with at least a first portion of an ad campaign;
receive second data indicative of awareness of a subject of the ad campaign by the panel of users;
determine, based on the first data, a first one or more timing characteristics associated with the first plurality of ad impressions; and
use a survival analysis to determine, based on the first data, the second data, and the first one or more timing characteristics, one or more factors indicative of an estimated effect of one or more attributes of a second plurality of ad impressions to an effectiveness of a second portion of the ad campaign associated with the second plurality of ad impressions.

24. The system of claim 23, further configured to:
receive third data indicative of the second plurality of ad impressions; and
determine, based on the third data and the one or more factors, an estimate of the effectiveness of the second portion of the ad campaign.
